(19) United States
(12) Patent Application Publication
(10) Pub. No.: US 2008/0140810 A1
(43) Pub. Date: Jun. 12, 2008

(54) SYSTEM AND METHOD FOR HIERARCHICALLY COMMUNICATING INFORMATION USING CACHE SERVER

(75) Inventors: Yong Sun KIM, Suwon-city (KR); Kyeongpyo Kim, Daejeon-city (KR); Jin Kyeong Kim, Daejeon-city (KR); Nae Soo Kim, Daejeon-city (KR); Cheol Sig Pyo, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ELECTRONICS AND TELECOMMUNICATIONS RESEARCH INSTITUTE, Daejeon-city (KR)

(21) Appl. No.: 11/947,547

(22) Filed: Nov. 29, 2007

(30) Foreign Application Priority Data
Dec. 7, 2006 (KR) 10-2006-0124152
Oct. 5, 2007 (KR) 10-2007-0100601

(51) Int. Cl. G06F 15/16

(52) U.S. Cl. 709/219

(57) ABSTRACT

Provided is a method and system for hierarchically communicating information between a user and an information providing server that provides information requested by the user. The system includes at least one sensor node, upon receipt of an information request message sent by the user through a terminal, searching for information corresponding to the information request message in a first cache mounted therein and sending the information request message if the corresponding information is not found in the first cache, and a cache server, upon receipt of the information request message from the at least one sensor node, searching for the information corresponding to the information request message in a second cache mounted therein, sending the information request message to the information providing server if the corresponding information is not found in the second cache, receiving the corresponding information, transmitting the received information to the sensor node, and updating the second cache.

### CROSS-REFERENCE TO RELATED PATENT APPLICATION

This application claims the benefit of Korean Patent Application No. 10-2006-0124152, filed on Dec. 7, 2006 and Korean Patent Application No. 10-2007-0100601, filed on Oct. 5, 2007 in the Korean Intellectual Property Office, the disclosures of which are incorporated herein in their entirety by reference.

### BACKGROUND OF THE INVENTION

1. Field of the Invention

The present invention relates to a system and method for hierarchically communicating information using a cache server upon request for data through a sensor node, and more particularly, to a system and method for communicating information which is capable of solving a bottleneck problem in an upper-level server, which may occur when a personal terminal requests a large amount of data through a radio frequency identification (RFID) tag or a sensor node in a place where people crowds, such as an airport, a railroad station, a subway station, a museum, an art gallery, an amusement park, and the like.

The present invention is derived from research conducted as a part of the IT new growth engine core technology development project of the Korean Ministry of Information and Communication [Subject No.: 2005-S-106-02, Subject Name: Development of Sensor Tag and Sensor Node Techniques for RFID/USN]

2. Description of the Related Art

Conventionally, for related information in an airport, a subway station, a museum, an art gallery, an amusement park, and the like, one can obtain uniform information that has been previously input using a radio frequency identification (RFID) tag, use identical information broadcasted to many people, or obtain information via the wireless Internet.

However, provided information is not appropriate as traffic information that is likely to change in real time or useless information is provided in most cases. As a result, such information is often misrecognized as spam and thus loses its value as information.

### SUMMARY OF THE INVENTION

The present invention provides a system and method which aims at a personalized service by providing only information desired by an individual without providing information that is not desired by the individual and is capable of solving a problem related to a large amount of data that is necessarily accompanied with the personalized service using a cache server having a hierarchical structure.

In the present invention, a bottleneck situation caused by a direct request for information to a final information providing server can be alleviated by hierarchically communicating information. To this end, a cache server communicates information between a terminal and the final information providing server, and a sensor node between the terminal and the cache server serves as another cache server, thereby alleviating the bottleneck situation caused by the direct request for information from the terminal to the final information providing server.

According to one aspect of the present invention, there is provided a system for hierarchically communicating information between a user and an information providing server that provides information requested by the user. The system includes at least one sensor node and a cache server. Upon receipt of an information request message sent by the user through a terminal, the at least one sensor node searches for information corresponding to the information request message in a first cache mounted therein and sends the information request message if the corresponding information is not found in the first cache. Upon receipt of the information request message from the at least one sensor node, the cache server searches for the information corresponding to the information request message in a second cache mounted therein, sends the information request message to the information providing server if the corresponding information is not found in the second cache, receives the corresponding information, transmits the received information to the sensor node, and updates the second cache.

According to another aspect of the present invention, there is provided a cache server which hierarchically communicates information with an information providing server that provides information requested by a user through a terminal. The cache server includes a transmitting/receiving unit, a cache unit, and a searching unit. The transmitting/receiving unit receives an information request message from the user through a sensor node and transmitting information corresponding to the information request message. The cache unit stores data about frequently used information in the information providing server and performing an update according to changes of data about frequently used information in the information providing server. Upon receipt of the information request message, the searching unit searches for information corresponding to the information request message in the cache unit to transmit the corresponding information to the transmitting/receiving unit if the corresponding information is found in the cache unit, and to transmit the corresponding information received to the transmitting/receiving unit by requesting to the information providing server if the corresponding information is not found in the cache unit.

According to another aspect of the present invention, there is provided a method of hierarchically communicating information between a user and an information providing server that provides information requested by the user. The method includes (a) upon receipt of an information request message in at least one sensor node sent by the user through a terminal, searching for information corresponding to the information request message in a first cache mounted in the sensor node and sending the information request message if the corresponding information is not found in the first cache; (b) upon receipt of the information request message in a cache server from the at least one sensor node, searching for the information corresponding to the information request message in a second cache mounted in the cache server; (c) receiving the corresponding information from the information providing server by requesting, if the corresponding information is not found in the second cache and updating the second cache; and (d) transmitting the received information from the information providing server to the sensor node.

According to another aspect of the present invention, there is provided a method of hierarchically communicating information between a user and an information providing server that provides information requested by the user through a terminal, by using a cache server. The method includes receiving a user's information request message in the cache server transmitted through at least one sensor node, storing data about frequently used information among data in the information providing server in the cache server and performing an update according to changes of data about frequently used information of the information providing server, upon receipt of the information request message by the cache server, searching for information corresponding to the information request message in the cache server and transmitting the corresponding information to the sensor node if the corresponding information is found in the cache server, and receiving the corresponding information from the information providing server by requesting, if the corresponding information is not found in the second cache and transmitting the received information to the sensor node.

### BRIEF DESCRIPTION OF THE DRAWINGS

The above and other features and advantages of the present invention will become more apparent by describing in detail an exemplary embodiment thereof with reference to the attached drawings in which:

FIG. 1 illustrates a system for hierarchically communicating information according to an exemplary embodiment of the present invention;

FIG. 2 illustrates the internal structure of a cache server according to an exemplary embodiment of the present invention;

FIG. 3 illustrates the internal structure of a terminal according to an exemplary embodiment of the present invention;

FIG. 4 is a flowchart illustrating a method of hierarchically communicating information between a user and an information providing server that provides information requested by the user according to an exemplary embodiment of the present invention; and

FIG. 5 is a flowchart illustrating a process of updating a sensor node and a cache of a cache server according to an exemplary embodiment of the present invention.

### DETAILED DESCRIPTION OF THE INVENTION

Hereinafter, an exemplary embodiment of the present invention will be described in detail with reference to the accompanying drawings. It should be noted that like reference numerals refer to like elements illustrated in one or more of the drawings. In the following description of the present invention, detailed description of known functions and configurations incorporated herein will be omitted for conciseness and clarity.

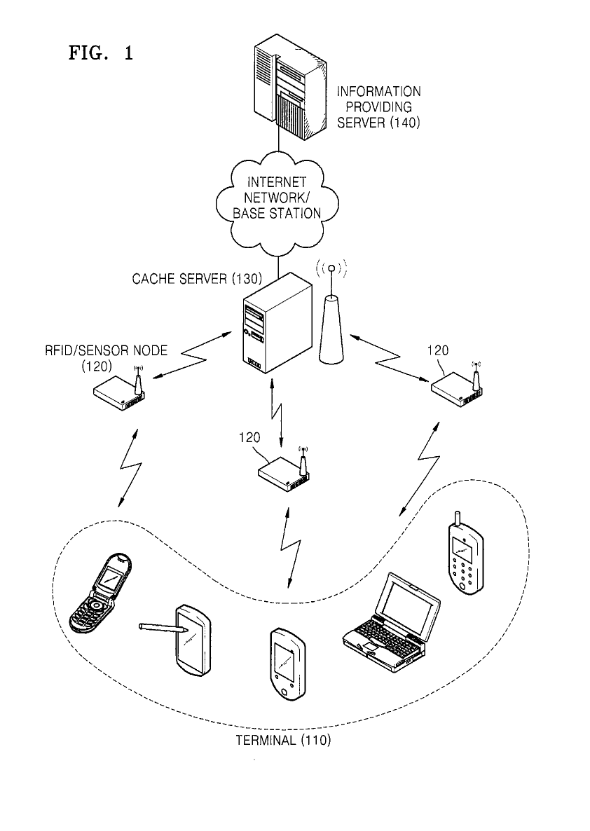

FIG. 1 illustrates a system for hierarchically communicating information according to an exemplary embodiment of the present invention.

Referring to FIG. 1, the system includes a terminal 110, at least one sensor node 120, a cache server 130, and an information providing server 140.

The terminal 110 may be a wireless communication device capable of transmitting and receiving a text message or a multimedia message, such as a cellular phone or a personal digital assistant (PDA). The terminal 110 has embedded therein a radio frequency identification (RFID) chip or a means for functioning as a sensor node in order to perform communication and receive information.

In order to request user desired information, the terminal 110 sends an information request message for the information to the information providing server 140 through the sensor node 120 that is installed in a range where wireless communication is possible. The user sends the information request message by inputting a keyword of the desired information to the terminal 110.

The sensor node 120 or an RFID reader installed in a range where wireless communication with the terminal 110 is possible receives the information request message and searches for the user desired information in its internal cache. If the user desired information is not found, the sensor node 120 sends the information request message to the cache server 130.

The sensor node 120 can store frequently used information in its internal cache. The sensor node 120 can also dynamically perform assignment of the cache according to the amount of information requested by terminals located in a range where wireless communication is possible. In this case, since the sensor node 120 stores information requested by only a terminal capable of performing wireless communication with the sensor node, it requires only a small-capacity memory.

Moreover, the memory of the cache of the sensor node 120 that stores frequently used information has a limited size and thus has to be shared with programs executed on the sensor node 120.

The sensor node 120 serves as a medium for communicating information between the terminal 110 and the cache server 130. The sensor node 120 first searches in its internal cache for information corresponding to the information request message received from the terminal 110. If the information is not found in the cache, the sensor node 120 sends the information request message to the cache server 130. The sensor node 120 then receives the information from the cache server 130 in order to update its internal cache and transmits the information to the terminal 110.

In the present invention, the terminal 110 may first receive stored information through the sensor node 120 or the RFID reader and then additionally receive information stored in the cache server 130 if detailed information is required. If more detailed information is further required, the terminal 110 sends the information request message for the information to the information providing server 140.

Upon receipt of the information request message from the sensor node 120, the cache server 130 searches for information corresponding to the information request message in the cache mounted therein.

If the corresponding information is found, the cache server 130 transmits the found information to the sensor node 120. If the corresponding information is not found, the cache server 130 sends the information request message for the information to the information providing server 140. The cache server 130 then transmits the information received from the information providing server 140 to the user through the sensor node 120. In this case, the cache of the sensor node 120 and the cache of the cache server 130 are updated.

The sensor node 120 manages only information about a terminal capable of performing wireless communication with the sensor node 120. However, the cache server 130 manages information about any terminal communicating with the sensor node 120, requiring more memories than the cache in the sensor node 120.

The information providing server 140 manages cache servers and records data in real time or retains additional detailed information that is not retained by the cache server 130. The information providing server 140 can be connected to the cache server 130 in a wireless manner through an Internet network or a base station. Upon receipt of the information request message from the cache server 130, the information providing server 140 searches for information in its database and transmits the found information to the cache server 130.

Such hierarchical connection can alleviate a bottleneck situation caused by direct connection of the terminal 110 to the final information providing server 140 and improve the utilization of wireless resources. Moreover, the information providing server 140 communicates information only with the cache server 130, thereby improving the efficiency of resource management. Moreover, the amount of data transmission between the cache server 130 and the sensor node 120 is reduced, thereby alleviating a bottleneck situation therebetween.

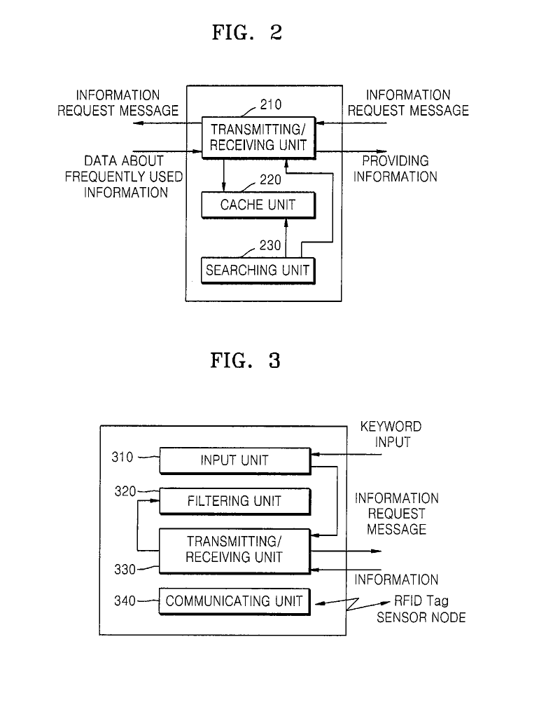

FIG. 2 illustrates the internal structure of the cache server 130 according to an exemplary embodiment of the present invention.

Referring to FIG. 2, the cache server 130 is in charge of intermediate communication between the sensor node 120 and the information providing server 140. The cache server 130 includes a transmitting/receiving unit 210, a cache unit 220, and a searching unit 230.

The information request message sent from the user using the terminal 110 is first received by the sensor node 120, and if information corresponding to the information request message is not found in the sensor node 120, the information request message is sent to the cache server 130.

The transmitting/receiving unit 210 receives the information request message from the sensor node 120 and receives data about frequently used information from the information providing server 140.

The cache unit 220 stores the data about the frequently used information, which is received from the information providing server 140, and performs update by comparing newly received data about frequently used information with the previously receive data about the frequently used information on a periodic basis or when a change occurs in data of the information providing server 140.

The searching unit 230 searches in the cache unit 220 for the information corresponding to the information request message. If the corresponding information is found in the cache unit 220, the searching unit 230 transmits the found information to the transmitting/receiving unit 210 and the transmitting/receiving unit 210 delivers the received information to the sensor node 120.

If the corresponding information is not found in the cache unit 220, the transmitting/receiving unit 210 sends the information request message to the information providing server 140. When the transmitting/receiving unit 210 receives the corresponding information later, the cache unit 220 performs update and sends the received information to the sensor node 120. The cache unit 220 performs update by receiving new information from the information providing server 140 and substituting the received new information for existing infrequently used information, thereby efficiently using limited computing resources.

The sensor node 120 transmits the information received from the cache server 130 to the terminal 110 that sends the information request message. Since the information request message includes a keyword of the information the user desires to search for, the terminal 110 filters only a portion of the received information, which matches the keyword and displays the filtered portion to the user.

As mentioned above, the user may send the information request message to the information providing server 140 through the sensor node 120 via the cache server 130 when the user needs more detailed information about the displayed information.

FIG. 3 illustrates the internal structure of the terminal 110 according to an exemplary embodiment of the present invention. The terminal 110 according to an exemplary embodiment of the present invention may be a cellular phone, a PDA, a notebook computer, or the like, which is capable of performing wireless communication. Referring to FIG. 3, the terminal 110 includes an input unit 310, a filtering unit 320, a transmitting/receiving unit 330, and a communicating unit 340.

The communicating unit 340 of the terminal 110 functions as a sensor node, but may communicate with an external device and collect information by including an RFID tag.

When the user inputs a keyword for searching for desired information to the input unit 310, the terminal 110 generates an information request message including the keyword and sends the information request message to the sensor node 120 through the transmitting/receiving unit 330. When the user receives the desired information through the sensor node 120 according to the above-described process, the filtering unit 320 displays only a portion of the received information, which matches the user input keyword.

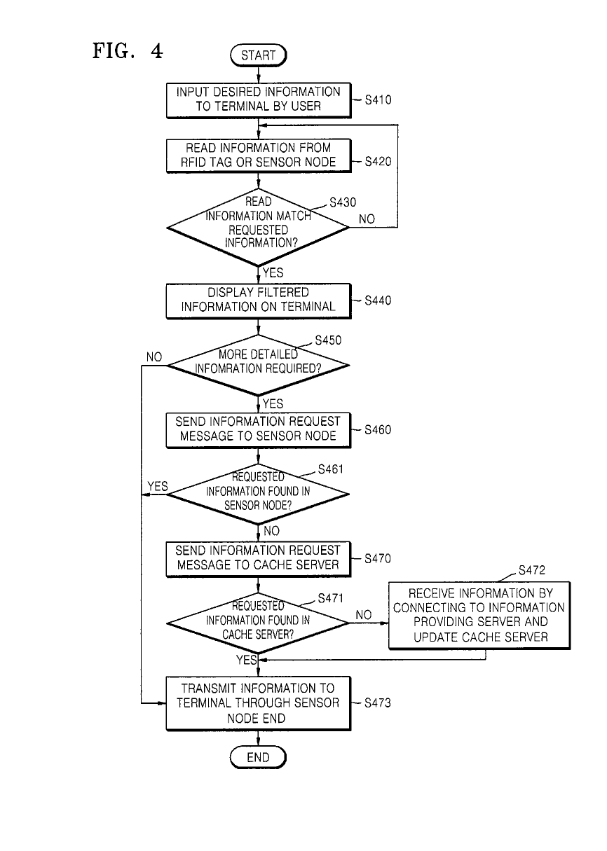

FIG. 4 is a flowchart illustrating a method of hierarchically communicating information between the user and the information providing server 140 that provides information requested by the user according to an exemplary embodiment of the present invention.

In operation S410, the user inputs an information request message for desired information to the terminal 110. It is determined whether information read from the sensor node 120 matches the desired information requested by the user, and if so, the read information is displayed on the terminal 110 in operations S420 through S440.

The user checks the displayed information, and sends the information request message to the sensor node 120 in operation S460 if more detailed information is required in operation S450. The sensor node 120 transmits information corresponding to the information request message to the terminal 110 if the corresponding information is found in the cache of the sensor node 120 in operation S461.

If the corresponding information is not found in the cache of the sensor node 120 in operation S461, the sensor node 120 sends the information request message to the cache server 130 in operation S470. The cache server 130 searches for the corresponding information in its cache in operation S471. If the corresponding information is found in the cache of the cache server 130, the cache server 130 transmits the found information to the sensor node 120 in operation S473. If the corresponding information is not found in the cache of the cache server 130, the cache server 130 receives the corresponding information by connecting to the information providing server 140, updates its cache and updates its cache, and transmits the received information to the sensor node 120 in operation S472. The sensor node 120 transmits the received information to the terminal 110 in operation S473.

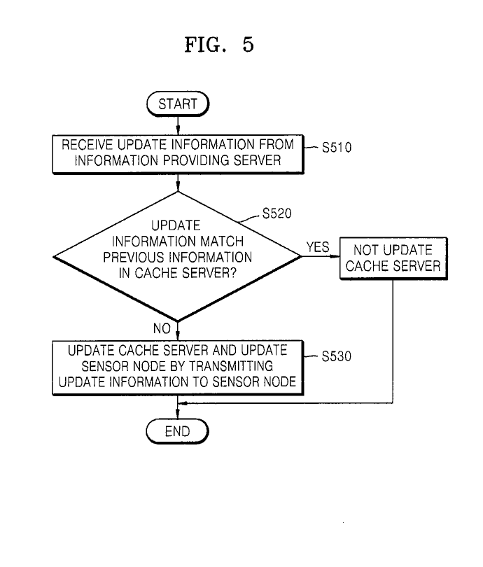

FIG. 5 is a flowchart illustrating a process of updating the sensor node 120 and the cache of the cache server 130 according to an exemplary embodiment of the present invention.

In operation S510, the cache server 130 receives update information related to data about frequently used information from the information providing server 140. It is determined whether the received update information matches data about frequently used information, which has already been stored in the cache server 130, in operation S520.

If the received update information matches the stored data, update is not performed. If the received update information does not match the stored data, the cache server 130 is updated and the cache of the sensor node 120 is also updated by transmitting the update information to the sensor node 120 in operation S530.

As described above, according to the present invention, a bottleneck situation caused by direct information request from the terminal to the information providing server can be greatly alleviated and the utilization of wireless resources can be improved.

Moreover, the sensor node between the terminal and the cache server serves as another cache server, thereby alleviating a bottleneck situation between the sensor node and the cache server.

In other words, with hierarchical connection suggested in the present invention, a bottleneck situation caused by the terminal's direct connection to the information providing server can be remarkably alleviated and the utilization of wireless resources can be improved.

The information providing server communicates information only with the cache server, thereby improving the efficiency of resource management. Furthermore, the amount of data transmission between the cache server and the sensor node is reduced and thus a bottleneck situation therebetween is also alleviated to the large extent.

The present invention can be embodied as a computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over network of coupled computer systems so that the computer-readable code is stored and executed in a decentralized fashion.

While the present invention has been particularly shown and described with reference to an exemplary embodiment thereof, it will be understood by those of ordinary skill in the art that various changes in form and detail may be made therein without departing from the spirit and scope of the present invention as defined by the following claims.

What is claimed is:

1. A system for hierarchically communicating information between a user and an information providing server that provides information requested by the user, the system comprising:
at least one sensor node, upon receipt of an information request message sent by the user through a terminal, searching for information corresponding to the information request message in a first cache mounted therein and sending the information request message if the corresponding information is not found in the first cache; and
a cache server, upon receipt of the information request message from the at least one sensor node, searching for the information corresponding to the information request message in a second cache mounted therein, sending the information request message to the information providing server if the corresponding information is not found in the second cache, receiving the corresponding information, transmitting the received information to the sensor node, and updating the second cache.

2. The system of claim 1, wherein the at least one sensor node transmits the corresponding information to the terminal if the corresponding information is found in the first cache and sends the information request message to the cache server if the corresponding information is found in the first cache and the information request message for detailed information about the corresponding information is further requested through the terminal.

3. The system of claim 1, wherein the cache server updates the first cache and transmits the corresponding information to the terminal through the sensor node if the corresponding information is found in the second cache, and updates the first cache and the second cache and transmits the corresponding information to the terminal through the sensor node if the corresponding information is received from the information providing server by requesting.

4. The system of claim 1, wherein the first cache stores frequently used information of the sensor node, and is updated based on the information received from the cache server.

5. The system of claim 1, wherein the second cache stores and updates data about frequently used information in the information providing server, and has a larger capacity than that of the first cache.

6. The system of claim 1, wherein the information request message comprises a keyword of the information requested by the user and the terminal filters only a portion of information received from the sensor node, which matches the keyword, and displays the filtered information.

7. The system of claim 1, wherein the sensor node is installed in a range where wireless communication with the terminal and the cache server is possible, and the cache server retains information about a terminal communicating with each of the at least one sensor node.

8. A cache server which hierarchically communicates information with an information providing server that provides information requested by a user through a terminal, the cache server comprising:
a transmitting/receiving unit receiving an information request message from the user through a sensor node and transmitting information corresponding to the information request message;
a cache unit storing data about frequently used information in the information providing server and performing an update according to changes of data about frequently used information in the information providing server; and
a searching unit, upon receipt of the information request message, searching for information corresponding to the information request message in the cache unit to transmit the corresponding information to the transmitting/receiving unit if the corresponding information is found in the cache unit, and to transmit the corresponding information received to the transmitting/receiving unit by requesting to the information providing server if the corresponding information is not found in the cache unit.

9. The cache server of claim 8, wherein the user receives information in the terminal from the transmitting/receiving unit through the sensor node.

10. The cache server of claim 8, wherein the information request message comprises a keyword of the information requested by the user and the terminal filters only a portion of information received from the sensor node, which matches the keyword, and displays the filtered information.

11. A method of hierarchically communicating information between a user and an information providing server that provides information requested by the user, the method comprising:
(a) upon receipt of an information request message in at least one sensor node sent by the user through a terminal, searching for information corresponding to the information request message in a first cache mounted in the sensor node and sending the information request message if the corresponding information is not found in the first cache;
(b) upon receipt of the information request message in a cache server from the at least one sensor node, searching for the information corresponding to the information request message in a second cache mounted in the cache server;
(c) receiving the corresponding information from the information providing server by requesting, if the corresponding information is not found in the second cache and updating the second cache; and
(d) transmitting the received information from the information providing server to the sensor node.

12. The method of claim 11, wherein the at least one sensor node transmits the corresponding information to the terminal if the corresponding information is found in the first cache and sends the information request message to the cache server if the corresponding information is found in the first cache and the information request message for detailed information about the corresponding information is further requested through the terminal.

13. The method of claim 11, wherein the cache server updates the first cache and transmits the corresponding information to the terminal through the sensor node if the corresponding information is found in the second cache, and updates the first cache and the second cache and transmits the corresponding information to the terminal through the sensor node if the corresponding information is received from the information providing server by requesting.

14. The method of claim 11, wherein the first cache stores frequently used information of the sensor node, and is updated based on the information received from the cache server.

15. The method of claim 11, wherein the second cache stores and updates data about frequently used information in the information providing server, and has a larger capacity than that of the first cache.

16. The method of claim 11, wherein the information request message comprises a keyword of the information requested by the user and the terminal filters only a portion of information received from the sensor node, which matches the keyword, and displays the filtered information.

17. The method of claim 11, wherein the sensor node is installed in a range where wireless communication with the terminal and the cache server is possible, and the cache server retains information about a terminal communicating with each of the at least one sensor node.

18. A method of hierarchically communicating information between a user and an information providing server that provides information requested by the user through a terminal, by using a cache server, the method comprising:
receiving a user's information request message in the cache server transmitted through at least one sensor node;
storing data about frequently used information among data in the information providing server in the cache server and performing an update according to changes of data about frequently used information of the information providing server;
upon receipt of the information request message by the cache server, searching for information corresponding to the information request message in the cache server and transmitting the corresponding information to the sensor node if the corresponding information is found in the cache server; and
receiving the corresponding information from the information providing server by requesting, if the corresponding information is not found in the second cache and transmitting the received information to the sensor node.

19. The method of claim 18, wherein the information request message comprises a keyword of the information requested by the user and the terminal filters only a portion of information received from the sensor node, which matches the keyword, and displays the filtered information.
